(19) United States
(12) Patent Application Publication
(10) Pub. No.: US 2018/0077682 A1
(43) Pub. Date: Mar. 15, 2018

(54) METHOD AND APPARATUS FOR APPLICATION AWARE NOTIFICATIONS IN A WIRELESS COMMUNICATION NETWORK

(71) Applicants: Xu LI, Nepean (CA); Aaron James CALLARD, Ottawa (CA); William Anthony GAGE, Stittsville (CA)

(72) Inventors: Xu LI, Nepean (CA); Aaron James CALLARD, Ottawa (CA); William Anthony GAGE, Stittsville (CA)

(73) Assignee: Huawei Technologies Co., Ltd., Shenzhen (CN)

(21) Appl. No.: 15/702,232

(22) Filed: Sep. 12, 2017

Related U.S. Application Data
(60) Provisional application No. 62/395,153, filed on Sep. 15, 2016.

(51) Int. Cl. H04W 68/02; H04W 72/04; H04W 68/00; H04W 52/02

(52) U.S. Cl. CPC H04W 68/025; H04W 72/042; H04W 52/0222; H04W 68/005; H04W 72/048

(57) ABSTRACT

A method and apparatus for application aware notifications in a wireless communication network are disclosed. The methods and apparatuses enable the transfer of at least some data to a UE or group of UEs without the specific need to establish a communication session for this data transfer. According to embodiments, the method and apparatus enable data to be transferred to a UE or a group of UEs along with a paging request. According to embodiments, downlink data to be transferred to a UE is integrated within a grant sent to the UE for transmission of uplink data.

### CROSS REFERENCE TO RELATED APPLICATIONS

This application claims the benefit of priority to U.S. Provisional Patent Application Ser. No. 62/395,153 filed on Sep. 15, 2016 and entitled Method and Apparatus for Application Aware Notifications in a Wireless Communication Network, the contents of which are incorporated by reference.

### FIELD OF THE INVENTION

The present invention pertains to the field of communication networks and in particular to methods and apparatuses for application aware notifications in a wireless communication network.

### BACKGROUND

In current wireless communication networks, a user equipment (UE) listens to paging messages to know about the availability of buffered downlink data, system information changes, Commercial Mobile Alert Service (CMAS) notifications, and Earthquake and Tsunami Warning Service (EWTS) notifications for ETWS capable UEs. In 3GPP Long Term Evolution (LTE), a UE needs to monitor the physical downlink control channel (PDCCH) periodically for the presence of a paging message.

Furthermore, a purpose of paging is to notify a UE which is in an idle mode when there is a communication or data for it to receive. To conserve radio resources and UE power, a UE which is not currently sending or receiving data can be placed into an idle mode in which the UE's radio can be powered down. A UE in idle mode checks for a paging message once every paging cycle, namely during a pre-determined paging occasion which defines the specific subframe within an LTE frame during which a paging message can be sent. The location of the paging occasion can be provided to the UE when it is being put into idle mode. In LTE the UE searches for downlink control information (DCI) encoded using the paging radio network temporary identifier (P-RNTI) within PDCCH at the specific subframe belonging to the assigned paging occasion. If a DCI encoded with the P-RNTI is detected, the UE decodes the paging message from PDSCH resource blocks indicated by the DCI and checks for its UE identity, for example as defined by its temporary mobile subscriber identity (TMSI), in all the paging records of the paging message. If the UE does not find its identity in the paging message then it will return to check the PDCCH for P-RNTI at each of the subsequent paging occasions. However, if the UE does find its identity, the UE triggers a random access procedure in order to establish a communication session for receiving the data pending for the UE, even if the amount of data pending is small. This random access procedure results in the UE being re-connected to the network, which results in network entities being able to determine where to send the buffered downlink data.

In addition, for group paging a group of UEs can share the same specific paging cycle, and thus can be assigned the same paging occasion. Moreover the group of UEs can be assigned the same group specific mobile subscriber identity. As such, if the group specific mobile subscriber identity is included in the paging message, all UEs in the group of UEs will attempt to establish a communication session, even if only some of the UEs in the group are actually required to establish a communication session, thus unnecessarily using network resources.

In LTE, when a UE is not in an idle mode, the UE may be configured to check for a pending downlink transmission by monitoring the PDCCH for its assigned RNTI at predefined times, for example every 60 ms or 100 ms, which can aid in the reduction of power consumption. The process of periodically monitoring the PDCCH for downlink transmissions using its assigned RNTI is known as Discontinuous Reception (DRX).

A UE in DRX mode checks the PDCCH for a pending downlink transmission during pre-configured subframes of every DRX cycle; these subframes are known as DRX reception opportunities. If the UE decodes a DCI encoded with its assigned RNTI within a DRX reception opportunity, the UE receives the downlink transmission in PDSCH resource blocks defined by the DCI. If the UE does not find a DCI encoded with its RNTI in the PDCCH then it will return to check PDCCH for its assigned RNTI during reception opportunities in the next DRX cycle.

Furthermore, when a UE is not in an idle mode, a UE may be assigned a semi-persistent schedule (SPS). The SPS provides the UE with pre-configured periodic uplink transmission opportunities and/or periodic downlink reception opportunities. At every transmission and/or reception opportunity, the UE may also be instructed to decode a DCI encoded with an SPS RNTI to determine the radio resources assigned for the uplink or downlink transmission.

Moreover a group of UEs can be assigned the same group specific RNTI. As such, if the group specific RNTI is used to encode a DCI, all UEs in the group of UEs will attempt to use the subsequent transmission opportunity, even if only some of the UEs in the group are the actual intended recipients, thus unnecessarily using network resources.

Therefore there is a need for a method and apparatus which enables data transfer that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for application aware notifications to one or more UEs. In accordance with an aspect of the present invention, there is provided a method for data transfer. The method includes receiving, by a network node, a configuration including one or more of a predicate structure and evaluation logic and receiving, by the network node, a first notification request including a first predicate and data. The method further includes transmitting, by the network node, a second notification request including a second predicate and the data, wherein transmitting is at least in part based on the first predicate evaluated using one or more of the predicate structure and the evaluation logic.

In some embodiments, the second notification request is a paging request or a data transfer request. According to some embodiments, the paging request or data transfer request is transmitted to one or more radio access nodes which are determined at least in part based on the first predicate evaluated using one or more of the predicate structure and evaluation logic.

In accordance with an aspect of the present invention, there is provided a method for data transfer during a period without a pre-existing communication session. The method includes receiving, by a network node, a notification including one or more of a predicate structure and evaluation logic and receiving, by the network node, a request including a first predicate and data. The method further includes transmitting, by the network node, a transmission including a second predicate and data, wherein transmitting is at least in part based on the first predicate evaluated using one or more of the predicate structure and the evaluation logic.

In accordance with an aspect of the present invention there is provided a network node for data transfer. The network node includes a processor and machine readable memory storing machine executable instructions which when executed by the processor configure the network node to perform any of the methods defined above.

In accordance with an aspect of the present invention, there is provided a method for data transfer during a period without a pre-existing communication session. The method includes receiving, by a user equipment (UE), configuration information including at least one of a predicate structure and evaluation logic associated with a predicate supporting data transfer. The method further including receiving, by the UE, a notification including the predicate and data.

In accordance with an aspect of the present invention, there is provided a user equipment (UE) for data receipt during a period without a pre-existing communication session. The UE includes a processor and machine readable memory storing machine executable instructions which when executed by the processor configure causes the UE to perform the methods defined above.

In accordance with an aspect of the present invention, there is provided a method for data transfer during a period without an established communication session between a UE and the network. The method includes transmitting, by a network node, a data transfer request including data and a predicate, wherein the predicate is indicative of one or more intended receivers of the data. In addition, the method includes the network node receiving a response to the data transfer request.

According to embodiments, the method also includes transmitting, by the network node, a configuration request including a predicate structure and evaluation logic, wherein the predicate structure is indicative of a predicate for data transfer. In addition, the method includes the network node receiving a response to the configuration request and subsequently transmitting a predicate and data.

In accordance with an aspect of the present invention, there is provided a method for data transfer during a period without an established communication session between a UE and the network. The method includes receiving, by the UE, a data transfer request including data and a predicate, wherein the predicate is indicative of one or more intended receivers of the data. In addition, the method includes the UE transmitting a response to the data transfer request.

The method also includes receiving, by a UE, a configuration request including a predicate structure and evaluation logic, wherein the predicate structure is indicative of a predicate for data transfer. In addition, the method includes the UE transmitting a response to the configuration request and subsequently receiving a predicate and data.

### BRIEF DESCRIPTION OF THE FIGURES

Further features and advantages of the present invention will become apparent from the following detailed description, taken in combination with the appended drawings, in which:

FIG. 1 illustrates a signalling diagram for application server initiated data transfer wherein the UE is in an idle mode, in accordance with embodiments of the present invention.

FIG. 2 illustrates a signalling diagram for application server initiated data transfer wherein the UE is not in an idle mode, in accordance with embodiments of the present invention.

FIG. 3 illustrates a signalling diagram for UE initiated data transfer, in accordance with embodiments of the present invention.

FIG. 4 illustrates a signalling diagram for enabling application aware notification in accordance with embodiments of the present invention.

FIG. 5 illustrates a signalling diagram for enabling application aware notification in accordance with embodiments of the present invention.

FIG. 6 illustrates a signalling diagram for application aware notification in accordance with embodiments of the present invention.

FIG. 7 illustrates coding modified in order to provide application aware paging in accordance with embodiments of the present invention.

FIG. 8 illustrates the coding modified in order to provide transmission of a predicate and, optionally, data in a grant notification such as a PDCCH DCI, in accordance with embodiments of the present invention.

FIG. 9 is a schematic diagram of a hardware device, accordance with embodiments of the present invention.

It will be noted that throughout the appended drawings, like features are identified by like reference numerals.

### DETAILED DESCRIPTION OF THE INVENTION

The present invention provides a method and apparatus which enables data transfer without the establishment of a communication session. The methods and apparatuses disclosed and described herein, can be used to enable the transfer of at least some data to a UE or group of UEs without the specific need to establish a communication session for this data transfer, thus the transfer of data can be enabled during a period without a pre-existing communication session. According to embodiments, the method and apparatus enable data to be transferred to a UE or a group of UEs along with the paging message. According to embodiments, downlink data to be transferred to a UE is integrated within a grant notification sent to the UE to allow for subsequent transmission of uplink data by the UE.

According to embodiments, there is provided a method for delivery of small amounts of downlink traffic or data, which can be provided by the integration of the data into a paging message or integrated into a grant notification, for example a grant to the UE for subsequent uplink transmission.

According to embodiments, the method and apparatus can provide short data delivery to a UE without the establishment of a communication session, (e.g. during a period without a pre-existing communication session). This data delivery can be defined in terms of one-to-one data delivery or one-to-many data delivery.

According to embodiments, a data field is embedded into a downlink paging message, wherein this data field can allow small amounts of data to be delivered to specifically referenced UEs. For example, embodiments can enable the sending of filtering information to grouped UEs, wherein the grouped UEs can share an identifier such as a System Architecture Evolution (SAE) temporary mobile subscriber identity (S-TMSI). This filtering information may provide a way for defining which UEs in the grouped UEs are to be responsive to the data that was received in the paging message. In some embodiments, the data received in the paging message can be provided, for example by the operating system (OS) of the UE(s), to the application layer for provision to a specific application operating on the UE. In some embodiments, the data may also result in the triggering of actions which result in the transfer of further data, for example, the data can cause the specifically identified UE(s) from the grouped UEs to commence establishment of a communication session for the transfer of the additional data.

According to embodiments, each of the grouped UEs can be configured to read the data received in the paging message. The data within the paging message can be used to trigger further action by a subset of the grouped UEs. In some embodiments, this further action may be to decode additional data, for example data that is received in the grant notification or to begin transition from an idle state to an active state. In some embodiments, the action may be to send a transmission on the uplink, which may be configured as polling using grant resources.

According to embodiments, the method and apparatus can provide for a customized UE wake up policy, for example a policy for one or more UEs to transition from an idle state to an active state. According to embodiments, the wake up policy can be configured by application data carried by the paging message (or configured in response to application data carried by the paging message). The UE can read the policy and subsequently determine if it is required to transition to an active state.

According to embodiments, the determination, by the UE, of whether a wake up should be performed can be useful for machine type communication (MTC) devices, for example massive MTC configurations. In this configuration, the communication network may not have to maintain information for individual MTC devices and communication with the MTC devices can be triggered based on customized paging messages being sent to a group of MTC devices. For example, some data indicative of filtering, predicate and qualifier information can be paged to a group of UEs and each UE in the group can determine if it is a qualified UE (e.g. if it is a UE that meets the requirements of the qualifier information).

According to embodiments, a predicate can define the group of UEs which are the intended targets for this transmission, for example the specific UE(s) and in some instances the specific application that is operational on the UE(s). Further, a predicate can include a protocol data unit (PDU) session ID, which identifies UEs associated with an intended target PDU session; a qualified UE can subsequently perform the appropriate action, for example activating a PDU session that is identified by the PDU session ID. It will be readily understood that the above are examples of a predicate, and that a predicate can be configured in a plurality of ways to define desired target or targets of the paging request. A qualified UE can subsequently perform the appropriate action such as transmit uplink data or transition from an idle state to an active state and commence establishment of a communication session.

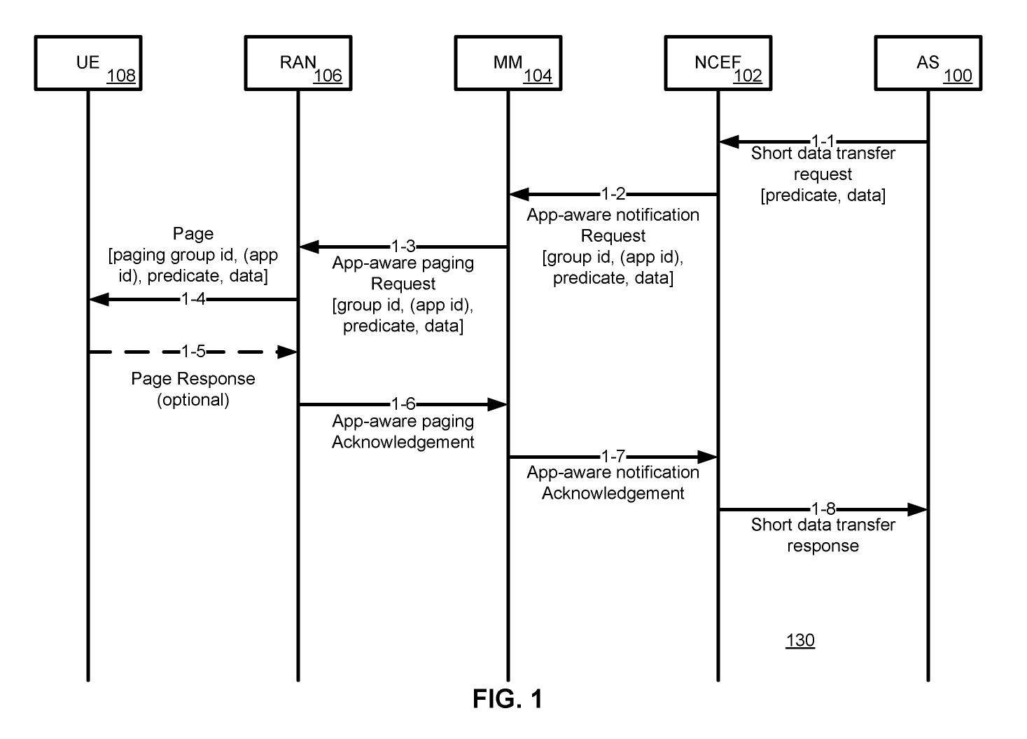

FIG. 1 illustrates a signalling diagram for a method 130, of an application server initiated short data transfer to UEs in an idle mode, in accordance with embodiments of the present invention. It will be readily understood that the transmission from the application server (AS) 100 can be configured as a multicast transmission, thus passing through a plurality of mobility managers (MMs) 104 and radio access nodes (RANs) 106 to be received by a plurality of UEs 108, for example a defined group of UEs. Those skilled in the art will appreciate that the term RAN is used here to denote a node 106, such as a base station or access point, within the radio access network that provides radio access to a UE 108. In the context of an LTE network, this node 106 may be an eNodeB, while in other networks it may be a NodeB. In the context of next generation networks, this may be a gNodeB. According to embodiments, the MMs 104 serve the role of mobility anchors and may or may not have control plane functionality. Examples of a MM 104 can include a serving gateway (SGW), mobility management entity (MME), a proxy mobility IP (PMIP) mobility anchor, user plane gateway (UP-GW), session management function (SMF) or the like. In some implementations the actions performed by the MM 104 may be split across multiple devices or functions, with different devices or functions performing different aspects. For example, the MM 104 may have a control component and a data plane component, wherein the control plane component selects the RAN nodes and the data plane component forwards the data. According to embodiments, the transmission can pass through a single network capability exposure function (NCEF) 102 or a combination of NCEFs which operate together to provide the required network functionality. According to embodiments, a NCEF 102 can be at least in part the same as a 3GPP service capability exposure function, (SCEF).

In the embodiment illustrated in FIG. 1 where the UE 108 is in an idle mode, the AS 100 transmits a short data transfer request 1-1 to an interworking function such as the NCEF 102. The short data transfer 1-1 can include the predicate and data. According to embodiments, the predicate can define a group of UEs which are the intended targets for this transmission, for example the specific UE(s) and in some instances the specific application that is operational on the UE(s). It will be readily understood that the above is an example of a predicate, and that a predicate can be configured in a plurality of ways to define desired target or targets of the short data transfer 1-1. The NCEF 102 evaluates or determines which MMs 104 are managing the group of UEs (or which MMs 104 are managing the UEs within the defined group) and initiates the short data transfer by transmitting a notification request 1-2 to those MMs. The notification request 1-2 can include predicate and data, wherein the predicate may include an application ID determined by the NCEF 102 based on predefined configuration information and evaluation logic. The MMs 104 may determine which RANs 106 are or have been providing communication access for the selected UEs 108. If the MMs 104 recognise that the UEs 108 are in an idle state, the MMs 108 can send application-aware paging requests 1-3 to the identified RAN 106. The application-aware paging request 1-3 can include the predicate and data. Alternatively, the MMs 104 may forward paging requests to all RANs 106 within their domain. Each RAN 106 in the plurality of RAN can then broadcasts a paging notification 1-4. Paging notification 1-4 can include a group ID, predicate and data field. The group ID may be specified by any or all of the MM 104, NCEF 102 and AS 100 or may be determined by the RAN 106 based on predefined predicate parsing and evaluation logic. In some embodiments, the data field includes data provided by the AS 100. In some embodiments, the data field includes a downlink grant (which may be encoded for example in the form of downlink control information, DCI) indicating resources within the physical downlink shared channel (PDSCH) where the RAN 106 will transmit the data provided by the AS 100. Upon the broadcast of the paging notification to the UEs 108, the RAN 106 can transmit a paging acknowledgement 1-6 to the MM 104; optionally, the RAN 106 may wait for one or more paging responses 1-5 from the UEs 108 or wait for a pre-determined page response time before transmitting the paging acknowledgement. The MM 104 subsequently transmits a notification acknowledgement 1-7 to the NCEF 102. The NCEF 102 can then transmit a short data transfer response 1-8 to the application server 100. It will be appreciated that the paging acknowledgements and the short data transfer response that are transmitted can be in the form of acknowledgements or negative acknowledgements depending on the actions performed by the RAN 106 and MM 104. In addition, in some embodiments, upon receipt of the paging notification by one or more of the intended UEs 108, a paging response, ACK or NACK can be subsequently transmitted by a UE 108 to the respective RAN 106. In some embodiments, one or more of the actions including the page response 1-5 sent by the UE 108, the paging acknowledgement 1-6 sent by the RAN 106, the notification acknowledgement 1-7 sent by the MM 104 and the short data transfer response 1-8 sent by the NCEF 102, may not occur, or alternately may occur in a different order to that illustrated. For instance the MM 104 may send a notification acknowledgement 1-7, before or without receiving a paging acknowledgement 1-6 from the RAN 106.

In some embodiments the formatting of the predicate received in the short data transfer request 1-1 may be modified by the NCEF 102. For example, the NCEF 102 may translate a message or predicate configured in a first format, for example RESTful HTTP configurations or SQL query language or the like, into a second format which can be a format expected by any or all of the MM 104, RAN 106 and UE 108. It will be readily understood that when translation of the message or predicate occurs, any or all of the NCEF 102, MM 104 and RAN 108 may receive a predicate or message, e.g. a first predicate or first message, and subsequently transmit a translated predicate or translated message, e.g. a second predicate or second message. While the above discussion is directed towards instances wherein there is a translation of the predicate or message by any or all of the NCEF 104, MM 104 and RAN 106, it will be readily understood that this is not to be considered limiting as there can be instances where the first predicate or first message are in fact the same as the second predicate or second message.

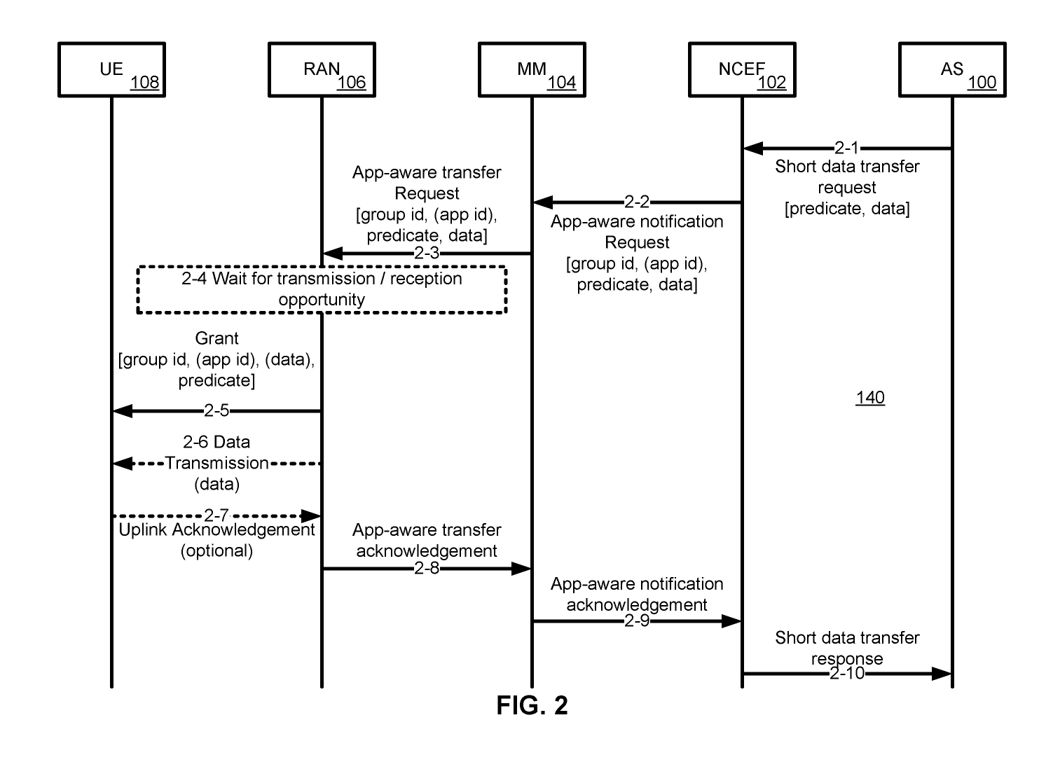

In the embodiment illustrated in FIG. 2, a signalling diagram of a method 140 is illustrated where the UE 108 is not in an idle mode, the AS 100 transmits a short data transfer request 2-1 to an interworking function such as the NCEF 102, and where the short data transfer 2-1 can include both predicate and data. According to embodiments, the predicate can define the group of UEs which are the intended targets for this transmission, for example the specific UE(s) and in some instances the specific application that is operational on the UE(s). The NCEF 102 evaluates which MMs 104 are managing the group of UEs (or which MMs 104 are managing the UEs within the group), and initiates the short data transfer by transmitting a notification request 2-2 to the MMs 104 supporting the UEs 108 within the group of UEs. Notification request 2-2 can include predicate and data. The predicate carried within notification request 2-2 may include an application ID determined by the NCEF 102 based on predefined configuration information and evaluation logic. The MMs 104 may determine which RANs 106 have been providing communication access for the selected UEs 108. If the MMs 104 recognise that the UEs 108 are not in an idle state, the MMs 104 can send application-aware transfer requests 2-3 that include the predicate and data to the RAN(s) 106 currently serving the UEs 108. Alternatively, the MMs 104 may forward transfer requests to all RANs 106 within their domain. If necessary, the RANs 106 wait for an uplink or downlink transmission opportunity 2-4 in an SPS schedule of transmission opportunities or reception opportunities in the next DRX cycle then transmit to the UE 108 a grant notification 2-5 such as a DCI encoded with the group RNTI in the PDCCH, wherein the grant notification can include the predicate identifying the intended recipients. In an uplink SPS transmission opportunity, the data may also be included in the grant notification 2-6. In a downlink SPS transmission opportunity or DRX reception opportunity, the data may be transmitted in the grant notification (DCI) or transmitted in the PDSCH resources indicated by the DCI. If a UE 108 decodes a grant notification (DCI) encoded with its assigned RNTI, SPS RNTI or a group RNTI during a transmission or reception opportunity, it can use the predicate in the DCI to determine whether it should act upon the received data. The action taken by the UE 108 in response to receipt of the predicate of grant 2-5 may, for example, include establishment of a communications session or transmission of uplink data. The group RNTI may be determined from a group ID specified by any or all of the MM 104, NCEF 102 and AS 100 or may be determined by the RANs 106 based on predefined predicate parsing and evaluation logic.

Upon the broadcast of the grant notification 2-5 to the UEs 108, the RAN 106 transmits a transfer acknowledgement 2-8 to the MM 104; optionally, the RAN 106 may wait for one or more uplink acknowledgments 2-7 from the UEs or wait for a pre-determined acknowledgement time before transmitting the transfer acknowledgement. The MM 104 subsequently transmits a notification acknowledgement 2-9 to the NCEF 102. The NCEF 102 can then transmit a short data transfer response 2-10 to the application server 100. It will be appreciated that the transfer acknowledgement 2-8 and notification acknowledgement 2-9 and the short data transfer response 2-10 that are transmitted can be in the form of acknowledgements or negative acknowledgements depending on the actions performed by the RAN 106 and MM 104. In addition, in some embodiments, upon receipt of the downlink transmission 2-6 by one or more of the intended UEs, an ACK or NACK 2-7 can be subsequently transmitted by a UE 108 to the respective RAN 106. In some embodiments, one or more of the actions including the acknowledgement 2-7 sent by the UE 108, the transfer acknowledgement 2-8 sent by the RAN 106, the notification acknowledgement 2-9 sent by the MM 104 and the short data transfer response 2-10 sent by the NCEF 102, may not occur, or alternately may occur in a different order to that illustrated. For instance the MM 104 may send a notification acknowledgement, before or without receiving a transfer acknowledgement from the RAN 106.

As noted above, according to embodiments, prior to the transmission of data using a paging message or a grant notification, the application server, UE 108 and network components there between, for example the radio access nodes (RANs) 106, mobility managers (MMs) 104 and the NCEF 102, are preconfigured and provided with information indicative of the predicate parsing and evaluation logic. This predicate parsing and evaluation logic can be used by the UE 108 and the various communication network components for the evaluation of a predicate and data configured in a paging request or grant notification or both. This preconfiguration of the UE 108 and the network components is discussed elsewhere herein.

Furthermore, when considering that the UE 108 is not in idle mode, for example the UE 108 is in connected mode from the perspective of the Core Network (CN), the UE 108 may be operating in a RAN inactive mode, for example Radio Resource Control (RRC) suspended or inactive state (e.g. RRC_INACTIVE state). In this embodiment, a case is considered wherein Downlink (DL) data is delivered by the CN to the RAN 106 that is serving this UE 108 or group of UEs. It is understood that the RAN 106 and UE(s) 108 may have been identified by evaluation of a predicate which may have been previously received by an interworking function such as the NCEF 102 or a MM 104. Upon receipt of this DL data, the RAN 106 can determine that the UE 108 is in a RAN active mode. The RAN 106 can buffers the DL data, and at the next paging opportunity, the RAN 106 can transmit a paging notification to the UE 108 in order to notify the UE 108 of the availability of buffered DL data. In some embodiments, the RAN 106 can integrate the DL data in the paging message broadcast to the UEs 108. Upon receipt of the paging notification, the UE 108 decodes the paging message thereby further obtaining the DL data.

In other embodiments, the RAN 106 can include DL resource assignment information in the paging message. Upon receipt of the paging message, the UE 108 decodes the paging message to obtain the DL resource assignment information. In some embodiments, the DL resource assignment information can be in the form of Downlink Control Information (DCI). Upon obtaining the DL resource assignment information, the UE 108 can subsequently receive the DL data according to the assigned DL resources.

In each of the above embodiments, for example when the RAN 106 includes the DL data in the paging message or the RAN 106 includes DL resource assignment information in the paging message, the UE 108 can be provided with a mechanism to receive DL data without transitioning into a RAN active mode of operation (such as RRC_CONNECTED state) and thus can receive the DL data while remaining in a RAN inactive mode of operation. Furthermore, while this scenario is described in terms of the downlink transmission, it would be readily understood by one of skill in the art how to modify the defined embodiments for uplink transmission.

Furthermore, while the above embodiments have been defined with respect to the transmission of DL data to a UE 108, these embodiments can be further considered to provide a mechanism for the RAN 106 to update a semi-persistent schedule, for example for one or both of the downlink or the uplink, to define a UL data channel or DL data channel for data transfer to or from the UE 106. In this case, the DL resource assignment (or UL resource assignment) information in the paging message describes the DL data channel (or UL data channel). It is understood that the semi-persistent schedule may be shared by a group of UEs. It is further understood that this updating of the semi-persistent schedule can be triggered by an internal need of the network.

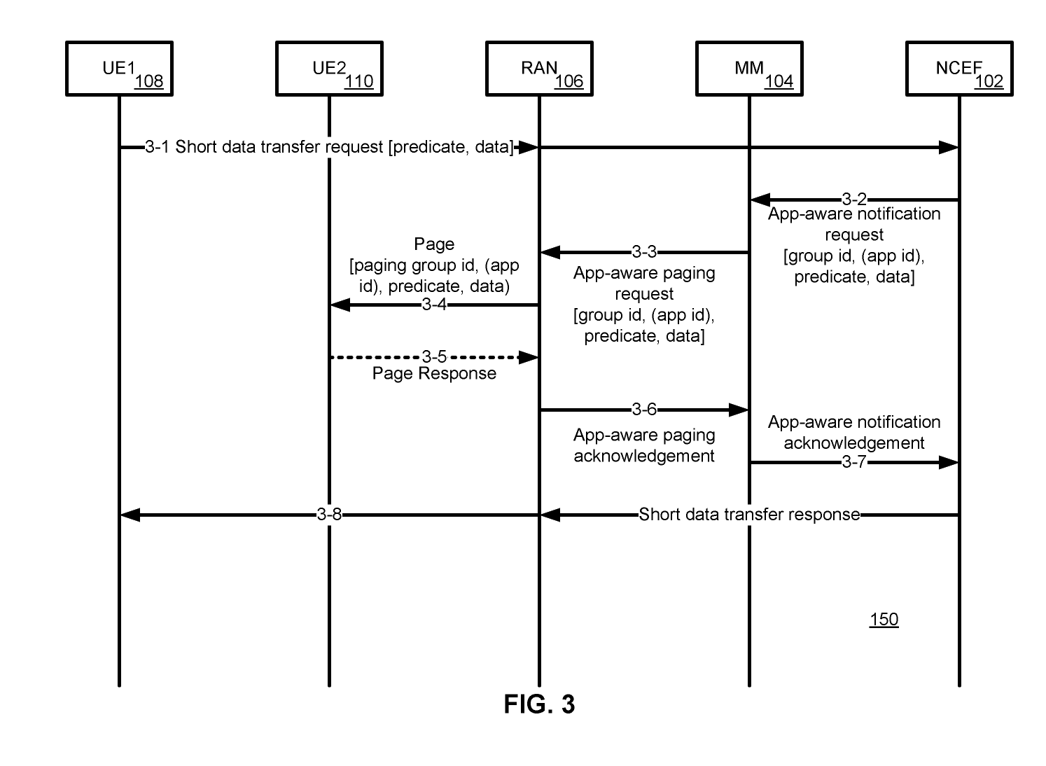

FIG. 3 illustrates a signalling diagram for a method 150, of a UE initiated data transfer from a first UE 108 to one or more other UEs, illustrated as UE2 110, in accordance with embodiments of the present invention. It will be readily understood that the transmission from the NCEF 102 can be configured as a multicast transmission, thus passing through a plurality of mobility managers (MMs) 104 and radio access nodes (RANs) 106 to be received by a plurality of UE2s 110, for example a defined group of UE2s.

In the embodiment illustrated in FIG. 3, the UE1 108 transmits a short data transfer request 3-1 to the NCEF 102. It should be understood that the short data transfer 3-1 can include the predicate and data, wherein the predicate can define the group of UEs (UE2 110) which are the intended targets for this transmission, for example the specific UE(s) and in some instances the specific application that is operational on the UE(s). It should also be understood that although illustrated as the UE1 108 transmitting a message 3-1 directly to NCEF 102, the message may pass through a number of intermediate nodes including RAN 106. The NCEF 102 evaluates which MMs 104 are managing the group of UEs (UE2 110) and transmits a notification request 3-2 to those MMs 104. Notification request 3-2 can include a predicate and data. The predicate carried within notification request 3-2 may include an application ID determined by the NCEF 102 based on predefined predicate parsing and evaluation logic. The MMs 104 may determine which RAN(s) 106 have been providing communication access for the selected UEs (UE2 110). The MMs 104 subsequently send application-aware paging requests 3-3 to the identified RAN(s) 106. Those skilled in the art will appreciate that this may also be understood as transferring the request to the identified RAN(s) 106. The paging request 3-3 sent to RAN 106 will typically comprise a predicate, which may include an application ID, and data. The RAN(s) 106 can then transmit a paging notification or grant notification 3-4 to the selected UEs (UE2 110). The paging notification or grant notification 3-4 can be encoded with a group ID and may include a predicate and data field, wherein the group ID may be determined by the RANs 106 based on predefined predicate parsing and evaluation logic. Upon the transmission of the paging notification or grant notification 3-4 to the UEs (UE2 110) or upon receipt of paging responses 3-5 from the UEs 110, RAN 106 can transmit a paging or transfer acknowledgement 3-6 to the MM 104. The MM 104 can then transmit a notification acknowledgement 3-7 to the NCEF 102. The NCEF 102 can then transmit a short data transfer response to the UE (UE1 108) 3-8 that originally initiated the data transfer. It will be appreciated that the acknowledgements 3-6, 3-7 and the short data transfer response 3-8 that are transmitted can be in the form of acknowledgements or negative acknowledgements depending on the actions performed by the RAN 106 and MM 104. In addition, in some embodiments, the upon receipt of the paging notification 3-4 by one or more of the intended UEs (UE2 110), a paging response 3-5, for example an ACK or NACK, can be transmitted to the respective RAN 106. It will be further understood that in some embodiments, acknowledgement of delivery of the message to UE2 110 does not need to be provided by NCEF 102 to UE1 108. This would make short data transfer response 3-8 an optional message in some embodiments.

Having further regard to FIG. 3, in some embodiments the UE1 108 transmits a short data transfer request directly to the MM 104 that is managing the group of UEs (UE2 110) with which UE1 108 is requesting the short data transfer. As used in reference to a transmission between UE1 108 and MM 104, the term directly will be understood to refer to a logical topology, as the connection between UE1 108 and MM 104 will pass through RAN 106 which provides the radio access link to allow UE1 108 to communicate with any of the other network functions. The short data transfer can include the predicate and data, wherein the predicate can define the group of UEs (UE2 110) which are the intended targets for this transmission and may optionally define or specify the relevant MM 104 which serves the UE2 110. In this embodiment, the UE1 108 has prior knowledge regarding the relevant MM 104 or the RAN 106 which serves a UE2 110 or is configured to determine the relevant MM 104 from the predicate. The MM 104 may determine which RANs 106 have been providing communication access for the selected UEs (UE2 110) and the MM 104 can subsequently send notification requests that include the predicate and data to the identified RANs 106. Alternatively, the MM 104 may forward notification requests to all RANs 106 within its domain. The RAN(s) 106 can then transmit a paging notification or grant notification to the selected UEs (UE2 110). The paging notification or grant notification 3-4 can include a group ID, predicate and data field. The group ID may be determined by the RAN(s) 106 based on predefined predicate parsing and evaluation logic. Upon the transmission of the paging notification or grant notification to the UEs (UE2 110) or upon receipt of responses from the UEs (UE2 110), the RAN 106 transmits a paging acknowledgement or transfer acknowledgement to the MM 104. The MM 104 can then transmit a short data transfer response to the UE (UE1 108) that originally initiated the data transfer. As before, the short data transfer response may be optional in some embodiments.

As previously noted according to embodiments, prior to the transmission of data using a paging notification or a grant notification, the application server, UE 108, 110 and communication network components there between, for example the radio access nodes 106 (RANs), mobility managers 104 (MM) and the NCEF 102, may be preconfigured and provided with information indicative of the predicate parsing and evaluation logic. This predicate parsing and evaluation logic can be used by the UE 108, 110 and the various communication network components for the evaluation of a predicate and data configured in any or all of the a paging and grant notification.

According to embodiments, the preconfiguration of the application server, UEs 108, 110 and communication network components there between can provide for a global uniqueness of the predicates, for example these predicates may contain application unique headers. Furthermore, by the provision of a validation and authorization of this preconfiguration, denial of service (DOS) attacks may be prevented or mitigated. In addition, the preconfiguration of the communication network components can enable a level of filtering of the data to be performed on the network side of the communication. This filtering may enable the sending of traffic, for example the paging requests, only to RAN(s) 106 which are serving UEs 110 for which the paging request are intended. This process can reduce the communication network overhead as unnecessary paging requests are not sent out. In addition, by the preconfiguration of the network components to the predicate that will be received in the subsequent paging request, the communication network is capable of verifying responses to the paging requests, as there can be an association of the responses with the predicate, for example responses between the UE 108, application server and network components may be associated with the predicate used when the paging request was first initiated. In this manner, a form of confirmation of guaranteed delivery may be enabled.

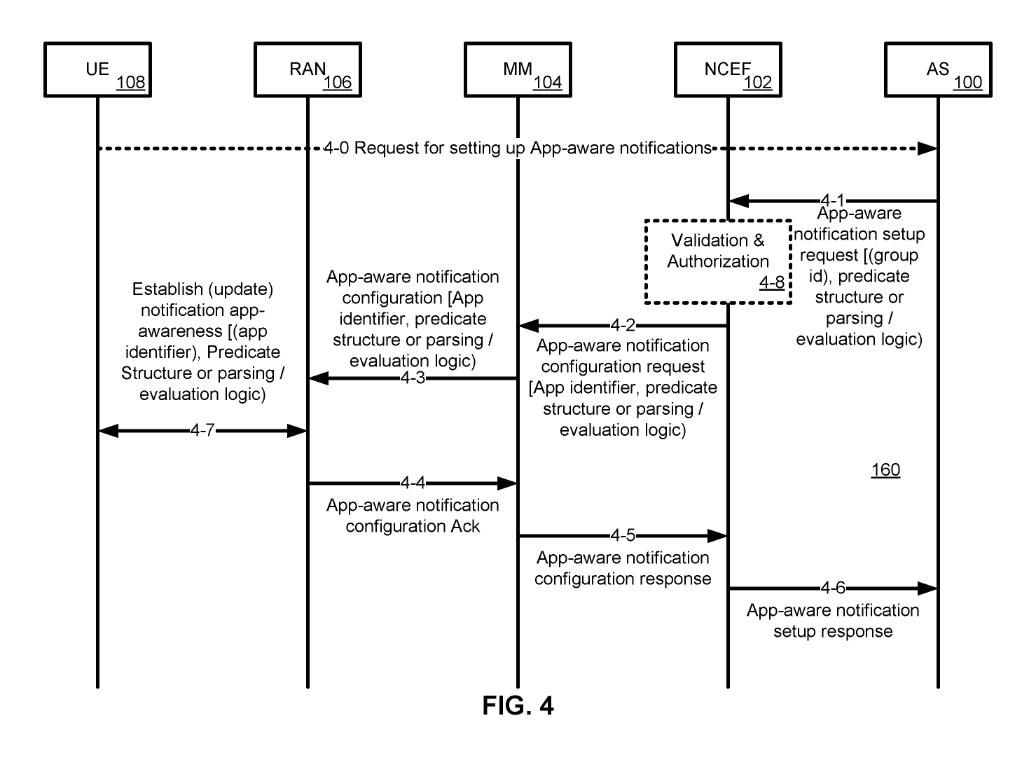

FIG. 4 illustrates a signalling diagram for a method 160, for enabling application aware notification in accordance with embodiments of the present invention. In this embodiment, the UE 108 optionally transmits a request for setting up application aware notification 4-0 to the application server 100. In response to the UE request 4-0 or autonomously according to logic within the application server 100, the application server 100 sends a notification setup request 4-1 together with at least one of a predicate structure, predicate parsing logic and evaluation logic. The application server 100 may further transmit a group ID, to the NCEF 102. In some embodiments, the group ID may identify the UE(s) 108 with which this requested notification setup is/are associated. The group ID may be used by functions within the communication network to determine suitable MMs 104 and RANs 106 in the network with which to configure the notification request. Upon receipt of setup request 4-1 the NCEF 102 can perform a process of validation and authorization 4-8 related to the application server 100 for requesting this notification setup. Upon validation and authorization of the notification setup request, the NCEF 102 transmits a notification configuration request 4-2 to the MM(s) 104. Notification notification configuration request 4-2 can include the application identifier and any or all of predicate structure predicate parsing logic and evaluation logic. In some embodiments, the MM(s) 104 transmits notification configuration message 4-3 which includes the application identifier and any or all of predicate structure, predicate parsing logic and evaluation logic to the RAN(s) 106. The RANs 106 subsequently communicate with the UE(s) 108 for establishing or updating notification application awareness 4-7. A notification configuration acknowledgement 4-4 can then be sent from the RAN(s) 106 to the MM(s) 104. In some embodiments, notification configuration requests and acknowledgements are transmitted directly between the MM(s) 104 and the UEs 108 wherein the information is transported transparently by the intervening RAN(s) 106. A notification configuration response 4-5 can subsequently be sent by the MM(s) 104 to the NCEF 102. The NCEF 102 then sends a notification setup response 4-6 to the application server 100. The notification setup response 4-6 indicates to the AS 100 that an application-aware notification setup has been performed. In some embodiments, the MM 104 can be bypassed and confirmation can be sent directly to the NCEF 102 by either the UE 108 or RAN 106 (depending on the embodiment).

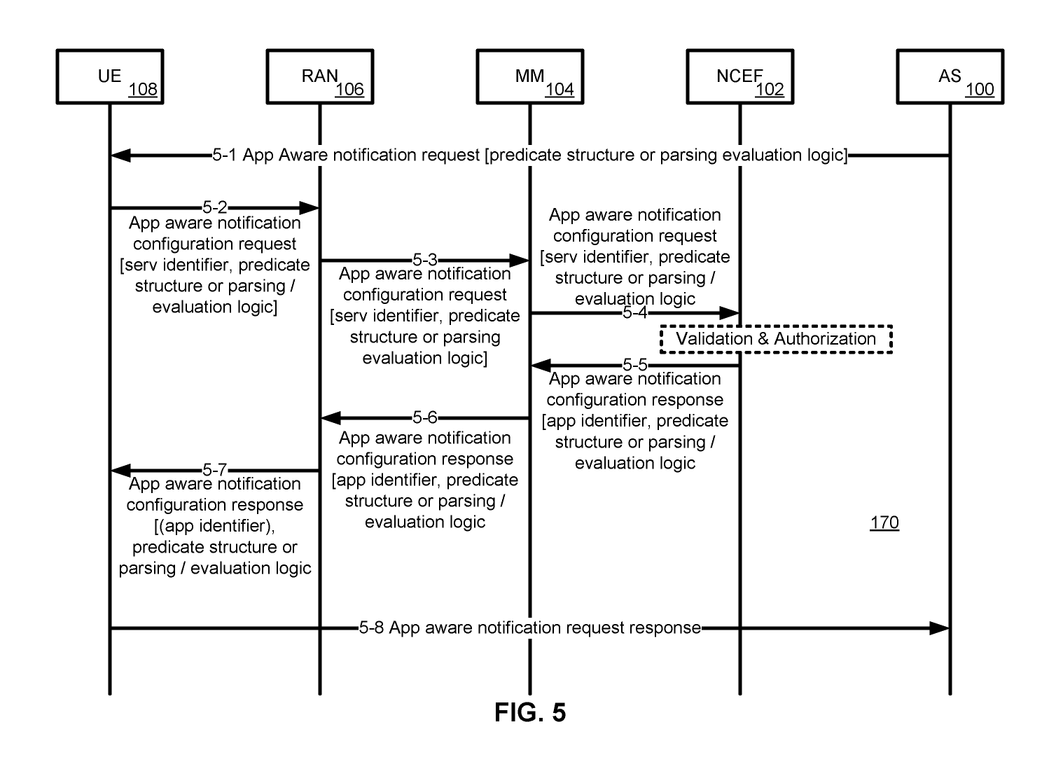

FIG. 5 illustrates a signalling diagram for a method 170 for enabling application aware notification in accordance with embodiments of the present invention. In this embodiment, the application server 100 transmits a request for application aware notification 5-1 to the UE(s) 108. This request 5-1 can include any or all of a predicate structure, predicate parsing logic and evaluation logic. The UE 108 can transmit, to a respective RAN 106, a notification configuration request 5-2, which can include the application server ID and any or all of a predicate structure, predicate parsing logic and evaluation logic. The RAN 106 transmits a similar request 5-3 to the MM 104 and the MM 104 transmits a similar request 5-4 to the NCEF 102. Upon receipt of this configuration request 5-4 the NCEF 102 can perform a process of validation and authorization related to the application server associated with this notification configuration request 5-4. Upon validation and authorization of the notification configuration request, the NCEF 102 transmits a paging configuration response 5-5 to the MM 104, which can include the application identifier, and any or all of a predicate structure predicate parsing logic and evaluation logic. The MM 104 transmits a notification configuration response 5-6 which includes the application identifier, and any or all of a predicate structure, predicate parsing logic and evaluation logic to the RAN 106. RAN 106 can transmit a similar response 5-7 to the UE 108. In some embodiments, notification configuration requests and acknowledgements are transmitted directly between the MM 104 and the UEs 108 wherein the information is transported transparently by the intervening RAN(s) 106. The UE 108 subsequently communicates with the application server 100 sending a notification request response 5-8. According to embodiments, the UE 108 can indicate to the RAN 106 what the device logic is, (device id, internal state, measurement parameters), and how the predicate is to be compared to that device logic. For example, bits 1 to X of the predicate can be interpreted as signed integers and can be compared with the device ID using less than or equal to operators. It would be readily understood that other procedures for enabling these comparisons are also possible.

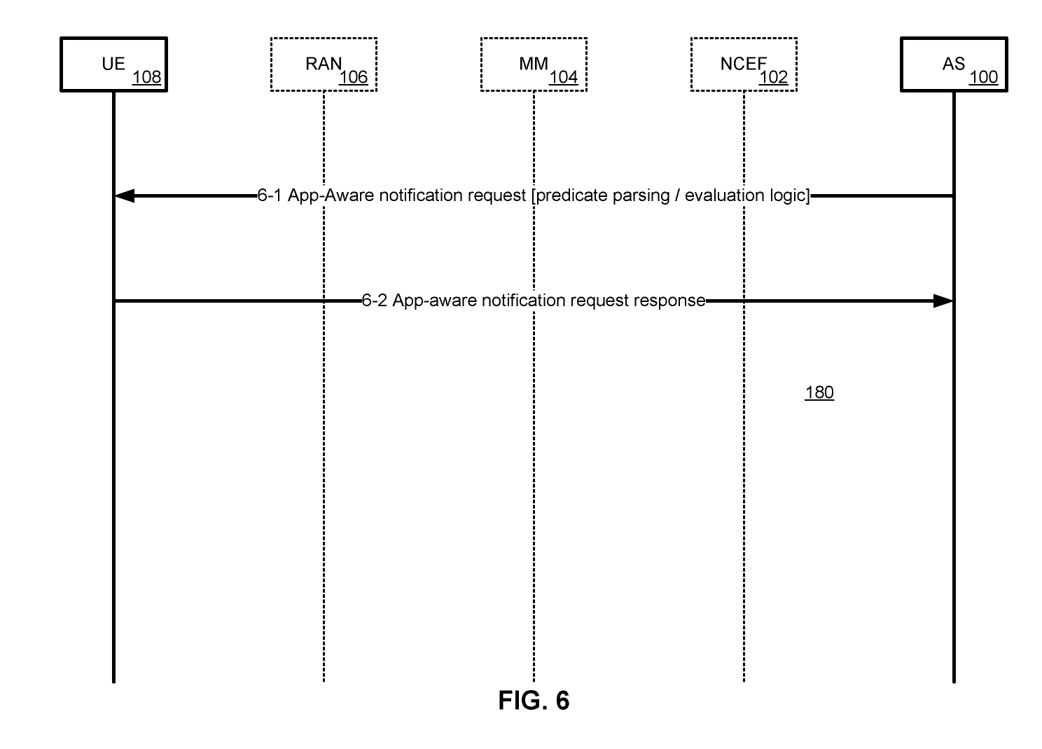

FIG. 6 illustrates a signalling diagram for a method 180 for an application aware notification in accordance with embodiments of the present invention. As illustrated in FIG. 6, there may be intervening nodes (e.g. NCEF 102, MM 104 and RAN 106) between the UE 108 and the AS 100, but from a logical connection perspective, the particulars of the intervening nodes may not be relevant. In this embodiment, the application server 100 sends an application aware notification request 6-1 to the UE 108, wherein the notification request 6-1 includes any or all of a predicate structure, predicate parsing logic and evaluation logic. The UE 108 subsequently sends an application aware notification request 6-2 response back to the application server 100. According to this embodiment, it is assumed that the UE 108 maintains service of the application, for example the UE 108 maintains application mapping. It is also assumed that the UE is capable of identifying the application from the application aware notification request. Furthermore it is assumed that the UE maintains the association between the predicate and the application. In addition, it is assumed that the UE is able to validate and authorize a request for the configuration of application aware notification on an as needed basis. In this embodiment, it is not necessary to preconfigure communication network components with information indicative of at any or all of the predicate structure, predicate parsing logic and evaluation logic.

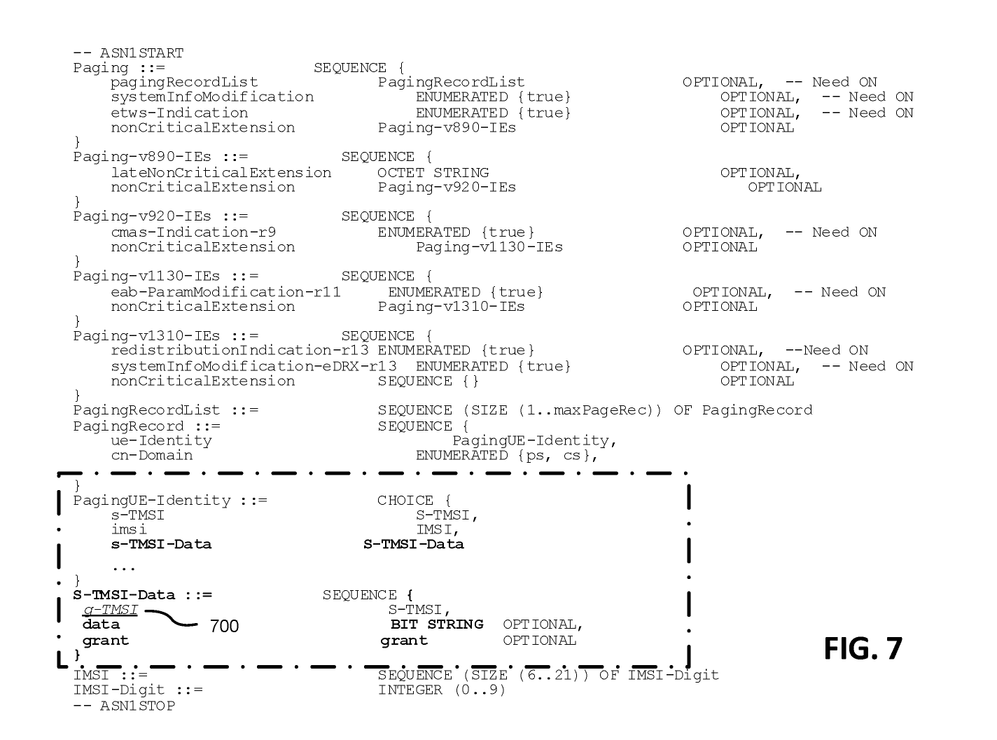

FIG. 7 illustrates an ANSI ASN.1 coding description modified in order to provide application aware notification in accordance with embodiments of the present invention. Having specific regard to FIG. 6, the coding modifications that may provide data transfer during transmission of a paging message such as notification 6-1 are indicated by the bold entries contained within the box with dashed and dotted lines. It will be readily understood that these coding modifications illustrate an example of how to enable data transfer during transmission of a paging message according to embodiments of the present invention. However, a worker skilled in the art would readily appreciate other ways of modifying the coding in order to provide data transfer during transmission of a paging message.

According to embodiments each device (UE) is assigned to a group which is identified by a S-TMSI. The S-TMSI can indicate a larger set of UEs to which the predicate will apply. The S-TMSI can be shared between all UEs in a group. The group may encompass UEs that have been subscribed to a particular service or belong to a particular operator/vendor/supplier or other parameter that is shared by the UEs using the same S-TMSI. This S-TMSI can be referred to as the application identifier, however according to some embodiments, the S-TMSI can have greater meaning, for example the S-TMSI may also be used for other communication or charging aspects relating to the UEs or both. According to embodiments, as illustrated in FIG. 7, the format of the group or application identifier g-TMSI 700 as defined by “S-TMSI-Data” can be S-TMSI, the same as that used for s-TMSI in “PagingUE-Identity”. However, in other embodiments the format of g-TMSI 700 can be different from S-TMSI.

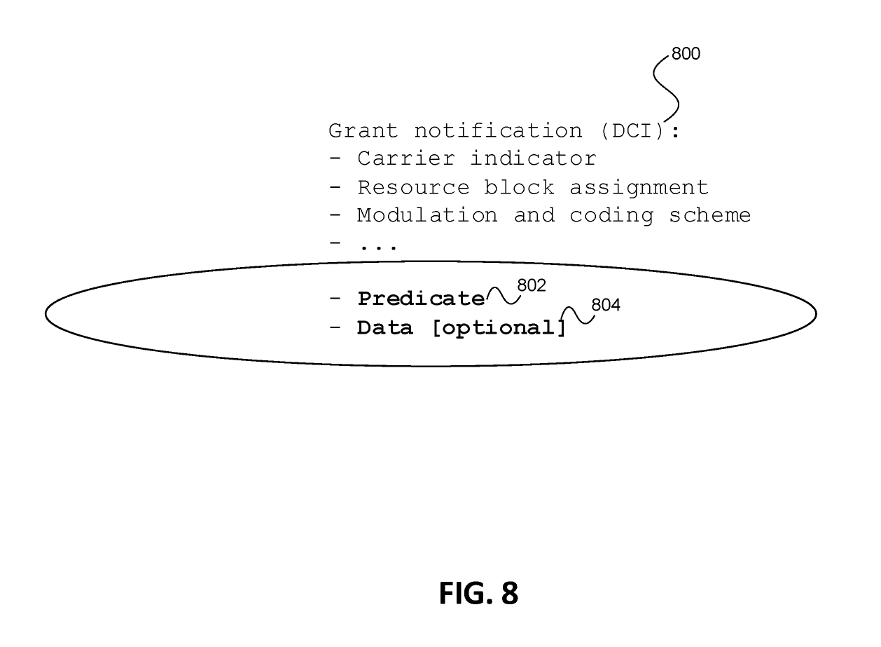

According to embodiments, the ‘grant’ field indicated in “S-TMSI-Data” of FIG. 7 can be a collection of information sufficient for the UEs to further decode information using other resources. For example, the information in the “grant” field can correspond to information commonly conveyed in the PDCCH channel, for example LTE DCI format, or other grant formats. Similarly, FIG. 8 illustrates some exemplary modifications to the coding description that may provide transmission of a predicate and, optionally, data in a grant notification such as a PDCCH DCI in accordance with embodiments of the present invention.

According to embodiments, a DCI 800 (such as a PDCCH DCI) may include a predicate 802 and may optionally also include data 804. The predicate 802 and data 804 (where appropriate) can be embedded within a grant notification providing a transmission grant. For example, the grant notification can be a grant for transmission of uplink data sent periodically to a group of UEs. Upon receipt of a grant notification encoded with a group identifier (RNTI), a UE can use the predicate 802 and, optionally, the data 804 included in the grant notification to determine whether it should transmit information during an indicated uplink transmission opportunity.

In some embodiments, if a paging notification is a unicast paging notification, for example one-to-one, then the predicate may be embedded in the unicast paging notification. In some embodiments, the cyclic redundancy check (CRC) of a PDCCH DCI can be masked using the predicate or a portion of the predicate. For example, this masking of the CRC using the predicate can be performed by using attribute-based-encryption to encrypt the CRC such that only the qualifying UE, for example with the proper attributes, can verify the CRC and subsequently proceed with the decoding of the message or data contained in the notification. For example, attribute-based-encryption can define a type of public-key encryption in which the secret key of a user and the ciphertext are dependent upon attributes, for example attributes of the user. The decryption of a ciphertext can be possible only if the set of attributes of the user key matches the attributes of the ciphertext.

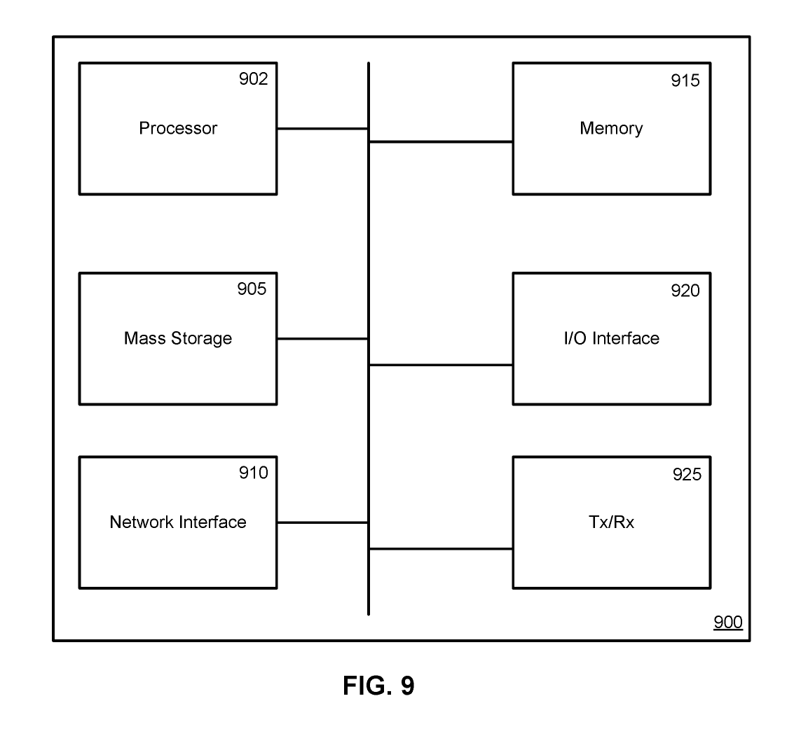

FIG. 9 is a schematic diagram of a hardware device or electronic device 900 that may for example, comprise nodes or functional entities of the communications system, or perform any or all of steps of the above methods and features described herein, according to different embodiments of the present invention. In some embodiments, the electronic device (ED) or hardware device may be an element of communications network infrastructure, such as a base station (for example a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a Public Land Mobility Network (PLMN). In other embodiments, the electronic device may be a device that connects to the network infrastructure over a radio interface, such as a mobile phone, smart phone or other such device that may be classified as a User Equipment (UE). In some embodiments, ED may be a Machine Type Communications (MTC) device (also referred to as a machine-to-machine (m2m) device), or another such device that may be categorized as a UE despite not providing a direct service to a user. In some references, an ED may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, transceivers etc. As shown, the device includes a processor 902 such as a Central Processing Unit (CPU), and may further include specialized processors such as a Graphics Processing Unit (GPU) or other such processor, memory 915, non-transitory mass storage 905, I/O interface 920, network interface 910, and a transceiver 925, all of which are communicatively coupled via bi-directional bus. According to certain embodiments, any or all of the depicted elements may be utilized, or only a subset of the elements. Further, device may contain multiple instances of certain elements, such as multiple processors, memories, or transceivers. Also, elements of the hardware device may be directly coupled to other elements without the bi-directional bus. The ED may optionally also include a video adapter or other component.

The memory may include any type of non-transitory memory such as static random access memory (SRAM), dynamic random access memory (DRAM), synchronous DRAM (SDRAM), read-only memory (ROM), any combination of such, or the like. The mass storage element may include any type of non-transitory storage device, such as a solid state drive, hard disk drive, a magnetic disk drive, an optical disk drive, USB drive, or any computer program product configured to store data and machine executable program code. In some embodiments, mass storage may be integrated with a heterogeneous memory. According to certain embodiments, the memory or mass storage may have recorded thereon statements and instructions executable by the processor for performing any of the aforementioned method steps described above.

The electronic device can include one or more network interfaces, which may include at least one of a wired network interface and a wireless network interface. A network interface may include a wired network interface to connect to a network, and also may include a radio access network interface for connecting to other devices over a radio link. When ED is a network infrastructure element, the radio access network interface may be omitted for nodes or functions acting as elements of the PLMN other than those at the radio edge (e.g. an eNB). When ED is infrastructure at the radio edge of a network, both wired and wireless network interfaces may be included. When ED is a wirelessly connected device, such as a User Equipment, radio access network interface may be present and it may be supplemented by other wireless interfaces such as WiFi network interfaces. The network interfaces allow the electronic device to communicate with remote entities such as those connected to network.

According to embodiments, a video adapter and the I/O interface provide interfaces to couple the electronic device to external input and output devices. Examples of input and output devices include a display coupled to the video adapter and an I/O device such as a touch-screen coupled to the I/O interface. Other devices may be coupled to the electronic device, and additional or fewer interfaces may be utilized. For example, a serial interface such as Universal Serial Bus (USB) (not shown) may be used to provide an interface for an external device. Those skilled in the art will appreciate that in embodiments in which ED is part of a data center, I/O interface and Video Adapter may be virtualized and provided through network interface.

In some embodiments, electronic device may be a standalone device, while in other embodiments electronic device may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

It should further be understood that different embodiments have been discussed in the context of individual features or elements. This has been for the sake of simplifying the discussion. Features and elements introduced in one embodiment may be combined with the features and elements introduced in other embodiments. In one non-limiting example provided solely for the purposes of illustration, in the method 170 illustrated in FIG. 5, a UE 108 pushes information towards the MM 104 and NCEF 102 to configure the predicate and data based paging messages, while method 150 illustrated in FIG. 3 provides a method of UE1 108 sending a paging message towards UE2 110. In method 150 of FIG. 4, the MM 104 received an app-aware notification request 3-2 from NCEF 102. When features and elements from the two methods are combined, the MM 104 may receive the app-awar notification request from either a UE 108 or RAN 106 (as shown by 5-3 in FIG. 5).

In embodiments, as discussed above, there is provide a method for data transfer during a period without an established communication session. This method comprises transmitting, by a network node, a request including a predicate structure and evaluation logic, the predicate structure being indicative of a predicate for data transfer; receiving, by the network node, a response to the request; and transmitting, by the network node, the predicate and data.

In a further embodiment, transmitting the predicate and data includes broadcasting to one or more recipients. In a further embodiment, transmitting the predicate and data includes transmitting a paging notification. In another embodiment, transmitting the predicate, the data, or both includes transmitting a grant notification. Optionally the grant notification is a grant for at least one of a downlink reception opportunity and an uplink transmission opportunity.

In other embodiments, there is provided a method for data transfer for execution at a network node, such as a mobility management function. The method for data transfer comprises receiving, by a network node, a configuration (which may be configuration information) including one or more of a predicate structure and evaluation logic; receiving, by the network node, a first notification request including a first predicate and data; and transmitting, by the network node, a second notification request including a second predicate and the data, wherein transmitting is at least in part based on the first predicate evaluated using one or more of the predicate structure and the evaluation logic.

In an embodiment, the second notification request is a paging request. Optionally the method further comprises receiving a paging acknowledgement. In a further optional embodiment, the paging request is transmitted to one or more identified radio access nodes (RANs) wherein the identified RANs are determined at least in part based on the first predicate evaluated using one or more of the predicate structure and the evaluation logic.

In an embodiment, the second notification request is a data transfer request. The data transfer request is configured to, upon reception at the destination, initiate transmission of a grant notification. In an optional embodiment, the method comprises receiving a data transfer acknowledgement. In another optional embodiment, the data transfer request is transmitted to one or more identified radio access nodes, RANs, wherein the identified RANs are determined at least in part based on the first predicate evaluated using one or more of the predicate structure and the evaluation logic.

In further embodiments, the method can be carried out at a mobility manager. The mobility manager may be a mobility anchor. In another embodiment, the configuration including one or more of a predicate structure and evaluation logic is received from one of an Application Server, an NCEF and a RAN and a UE. The configuration may be received directly from one of the above mentioned nodes or functions, or it may be received indirectly.

The first notification request may be received from any or all of the NCEF, RAN and UE. In some embodiments, the notification request may originate at an Application Server, and in such embodiments, the notification request may be sent through either the NCEF, or through a UE (via a RAN) to the MM.

In a further embodiment, there is provided a network node for transferring data in accordance with the method for data transfer described in the above embodiment. The network node comprises a network interface, a processor and a memory. The memory is machine readable and stores instructions that when executed by the processor cause the network node to be configured to carry out the method described above. The various embodiments of this method can also be applied mutatis mutandis to the network node.

It will be further understood that as defined by the LTE standards, a UE in idle mode is assigned a paging cycle. At fixed points in the cycle, the UE will wake up from a power saving mode in which the radio is powered down, and listen for a broadcast page. Upon receipt of the broadcast page, the UE will examine the page to determine if the page includes an identifier associated with the UE. If the identifier associated with the UE is included in the broadcast page, the UE initiates a service request so that it can retrieve the buffered data. If the identifier associated with the UE is not included the in the broadcast page, the UE can return to the power saving mode in which the radio is powered down. This power saving mode is often referred to as a sleep mode. As described above, the behavior of the UE may be different under the disclosed methods. A UE that is in an idle mode (or an RRC inactive mode) will wake up to receive a broadcast page. The UE will process the received broadcast page. If an identifier associated with the UE is present in the broadcast page, the UE will perform further processing (e.g. an examination of the predicate). Responsive to a determination that the broadcast page that includes an identifier associated with the UE contains an instruction or request that the UE connect to the network, the UE can connect to the network in one form or another. This may entail transmitting a service request, interacting with a radio access node to exit an RRC inactive state, or other such activities. It will also be understood that a UE, having received a broadcast page including an identifier associated with the UE, may return to a sleep state (e.g. a power saving state in which radio functions are powered down) without attempting to further connect to the network. When the further processing of the predicate does not specify an action for or request of the UE, the UE may return to the sleep state without connecting to the network.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. Moreover, in some instances the present invention has been described using reference to terminology specific to LTE, it is readily understood that the use of these terms is meant to be illustrative and not limiting. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for data transfer during a period without a pre-existing communication session, the method comprising:
receiving, by a user equipment (UE), configuration information including at least one of a predicate structure and evaluation logic associated with a predicate supporting data transfer; and
receiving, by the UE, a notification comprising the predicate and data.

2. The method according to claim 1, wherein the notification comprising the predicate and data is a paging notification.

3. The method according to claim 1, wherein the notification comprising the predicate and data is a grant notification.

4. The method of claim 1 further comprising determining a subsequent action in accordance with an evaluation of the predicate and data received, evaluation being performed in accordance with the at least one of the predicate structure and the evaluation logic.

5. The method of claim 1 wherein the notification comprising the predicate and data are received from a radio access node.

6. A user equipment (UE) for data receipt during a period without a pre-existing communication session, the network node comprising:
a processor; and
machine readable memory storing machine executable instructions which when executed by the processor configure the UE to:
receive configuration information including at least one of a predicate structure and evaluation logic associated with a predicate supporting data transfer; and
receive a notification comprising the predicate and data.

7. The UE according to claim 6, wherein the notification comprising the predicate and data is a paging notification.

8. The UE according to claim 6, wherein the notification comprising the predicate and data is a grant notification.

9. The UE of claim 6, wherein the machine readable code which when executed by the processor further configures the UE to determine a subsequent action in accordance with an evaluation of the predicate and data received, evaluation being performed in accordance with the at least one of the predicate structure and the evaluation logic.

10. A method for data transfer during a period without a pre-existing communication session, the method comprising:
receiving, by a network node, a notification including one or more of a predicate structure and evaluation logic;
receiving, by the network node, a request including a first predicate and data; and
transmitting, by the network node, a transmission including a second predicate and data, wherein transmitting is at least in part based on the first predicate evaluated using one or more of the predicate structure and the evaluation logic.

11. The method according to claim 10, wherein the request is a paging request and the transmission is a paging notification.

12. The method according to claim 11, wherein the data is downlink data.

13. The method according to claim 11, wherein the data is downlink resource assignment information.

14. The method according to claim 10, wherein the transmission is a grant notification.

15. The method of claim 10 wherein the network node carrying out the procedure is a radio access node.

16. The method of claim 10 wherein the step of transmitting includes transmitting the transmission including the second predicate and data to a User Equipment.

17. The method of claim 16 wherein transmitting to a User Equipment includes broadcasting the transmission.

18. A network node for transferring data during a period without a pre-existing communication session, the network node comprising:
a processor; and
machine readable memory storing machine executable instructions which when executed by the processor configure the network node to:
receive a notification including one or more of a predicate structure and evaluation logic;
receive a request including a first predicate and data; and
transmit a transmission including a second predicate and data, wherein transmitting is at least in part based on the first predicate evaluated using one or more of the predicate structure and the evaluation logic.

19. The network node according to claim 18, wherein the request is a paging request and the transmission is a paging notification.

20. The network node according to claim 18, wherein the data is downlink data.

21. The network node according to claim 18 wherein the data is downlink resource assignment information.

22. The network node according to claim 18, wherein the transmission is a grant notification.

23. The network node of claim 18 wherein the network node is a radio access node.
